(19) United States
(12) Patent Application Publication
(10) Pub. No.: US 2025/0381972 A1
(43) Pub. Date: Dec. 18, 2025

(54) INFORMATION TRANSMISSION DEVICE

(71) Applicant: TOYOTA JIDOSHA KABUSHIKI KAISHA, Toyota-shi (JP)

(72) Inventors: Hisanobu INOUE, Kawasaki-shi (JP); Hironori Ito, Tokyo (JP)

(73) Assignee: TOYOTA JIDOSHA KABUSHIKI KAISHA, Toyota-shi (JP)

(21) Appl. No.: 19/184,565

(22) Filed: Apr. 21, 2025

(30) Foreign Application Priority Data
Jun. 17, 2024 (JP) 2024-097251

(51) Int. Cl. B60W 50/14; B60W 10/20; B60W 30/09; B60W 30/14; B60W 30/16

(52) U.S. Cl. CPC B60W 50/14; B60W 10/20; B60W 30/09; B60W 30/146; B60W 30/16; B60W 2050/146; B60W 2520/10; B60W 2540/215; B60W 2554/80; B60W 2556/45

(57) ABSTRACT

An information transmission device includes an information acquisition unit configured to acquire traveling information including a surrounding situation and vehicle behavior of a host vehicle, for each execution target scene of a control program for controlling traveling of the host vehicle, a confirmation unit configured to confirm with a user whether or not it is acceptable to transmit the traveling information to an information collection device, for each acquired traveling information, and a transmission unit configured to transmit the traveling information for which the user determines that the transmission is acceptable, to the information collection device.

### CROSS-REFERENCE TO RELATED APPLICATIONS

This application is based upon and claims the benefit of priority from Japanese Patent Application No. 2024-097251, filed on Jun. 17, 2024, the entire contents of which are incorporated herein by reference.

### TECHNICAL FIELD

The present disclosure relates to an information transmission device that transmits traveling information of a vehicle.

### BACKGROUND

For example, Japanese Unexamined Patent Publication No. H07-108849 describes a device that is provided with a unit that detects a surrounding situation and a unit that detects a traveling state of a vehicle, and that learns a driving method of a driver based on detection results detected by these two units. This device causes the vehicle to autonomously travel based on the learning result.

### SUMMARY

The traveling information including the surrounding situation and the vehicle behavior of the vehicle is useful for developing a control program for controlling the traveling of the vehicle. For this reason, it is preferable that such traveling information can be collected, but there is also a user who does not want such information to be collected without permission.

Therefore, the present disclosure describes an information transmission device that can transmit acquired traveling information according to a user's intention.

An information transmission device according to an aspect of the present disclosure is [1] “An information transmission device including: an information acquisition unit configured to acquire traveling information including a surrounding situation and vehicle behavior of a vehicle, for each execution target scene of a control program for controlling traveling of the vehicle; a confirmation unit configured to confirm with a user whether or not it is acceptable to transmit the traveling information to an information collection device, for each acquired traveling information; and a transmission unit configured to transmit the traveling information for which the user determines that the transmission is acceptable, to the information collection device”.

When transmitting the traveling information acquired for each execution target scene of the control program, the information transmission device confirms with the user whether or not it is acceptable to transmit the traveling information. Then, the information transmission device transmits the traveling information for which the user determines that the transmission is acceptable, to the information collection device. Accordingly, the information transmission device can transmit the acquired traveling information according to the user's intention.

The information transmission device according to the aspect of the present disclosure may be [2] “The information transmission device according to [1], in which the information acquisition unit is configured to acquire the traveling information in the execution target scene of an unpermitted control program that is the control program that is not permitted to be executed in the vehicle, and the confirmation unit is configured to display vehicle behavior predicted when the unpermitted control program is executed and actual vehicle behavior on a display, and confirm whether or not it is acceptable to transmit the traveling information in the execution target scene of the unpermitted control program”.

In this case, the user can recognize a difference between the vehicle behavior when the unpermitted control program is executed and the actual vehicle behavior by viewing the display. Then, the user can determine whether or not to transmit the traveling information in the execution target scene of the unpermitted control program based on this difference.

The information transmission device according to the aspect of the present disclosure may be [3] “The information transmission device according to [2], in which the confirmation unit is configured to, when a deviation amount between the vehicle behavior predicted when the unpermitted control program is executed and the actual vehicle behavior is equal to or greater than a predetermined deviation amount threshold value, display the vehicle behavior predicted when the unpermitted control program is executed and the actual vehicle behavior on the display, and confirm whether or not it is acceptable to transmit the traveling information in the execution target scene of the unpermitted control program”.

In this case, the user can confirm a difference in vehicle behavior and determine whether or not to transmit the traveling information when the deviation amount between the vehicle behavior when the unpermitted control program is executed and the actual vehicle behavior is large.

The information transmission device according to the aspect of the present disclosure may be [4] “The information transmission device according to [3], in which the unpermitted control program is a control program for executing control of decelerating the vehicle, the deviation amount is a deviation amount of a deceleration rate, and the confirmation unit is configured to, when the deviation amount between a deceleration rate of the vehicle predicted when the unpermitted control program is executed and an actual deceleration rate of the vehicle is equal to or greater than a predetermined deviation amount threshold value, display the vehicle behavior predicted when the unpermitted control program is executed and the actual vehicle behavior on the display, and confirm whether or not it is acceptable to transmit the traveling information in the execution target scene of the unpermitted control program”.

In this case, when the deviation amount between the deceleration rate of the vehicle when the unpermitted control program is executed and the actual deceleration rate of the vehicle is large, the user can confirm the difference in vehicle behavior and determine whether or not to transmit the traveling information.

The information transmission device according to the aspect of the present disclosure may be [5] “The information transmission device according to [3], in which the unpermitted control program is a program for executing control of adjusting a spacing between the vehicle and an obstacle around the vehicle by controlling at least any of a speed or steering of the vehicle, the deviation amount is a deviation amount of a spacing between the vehicle and the obstacle, and the confirmation unit is configured to, when a deviation amount between a spacing between the vehicle and the obstacle, which is predicted when the unpermitted control program is executed, and an actual spacing between the vehicle and the obstacle is equal to or greater than a predetermined deviation amount threshold value, display the vehicle behavior predicted when the unpermitted control program is executed and the actual vehicle behavior on the display, and confirm whether or not it is acceptable to transmit the traveling information in the execution target scene of the unpermitted control program”.

In this case, when the deviation amount between the spacing between the vehicle and the obstacle when the unpermitted control program is executed and the actual spacing between the vehicle and the obstacle is large, the user can confirm the difference in vehicle behavior and determine whether or not to transmit the traveling information.

The information transmission device according to the aspect of the present disclosure may be [6] “The information transmission device according to any one of [3] to [5], in which the confirmation unit is configured to set the deviation amount threshold value to be larger when a speed of the vehicle is low than when the speed of the vehicle is high”.

For example, when the speed of the vehicle is low, the user (driver) of the vehicle may perform a driving operation of intentionally approaching the obstacle very close and passing through the obstacle. In this way, when the speed of the vehicle is low, the deviation amount between the vehicle behavior predicted when the control program is executed and the actual vehicle behavior may be intentionally increased by the driving operation intended by the user. Therefore, when the speed of the vehicle is low, the confirmation unit suppresses the confirmation of whether or not it is acceptable to transmit the traveling information, by increasing the deviation amount threshold value. As a result, it is possible to suppress the confirmation of whether or not it is acceptable to transmit the traveling information due to the large deviation amount even though the deviation amount is intentionally increased by the driving operation intended by the user.

The information transmission device according to the aspect of the present disclosure may be [7] “The information transmission device according to any one of [1] to [6], in which the information acquisition unit is configured to not acquire the traveling information when an instruction to prohibit the acquisition of the traveling information is input by the user”. In this case, the user can prohibit the acquisition of the traveling information when the acquisition of the traveling information is not desired. Accordingly, the information transmission device can acquire the traveling information according to the user's intention.

The information transmission device according to the aspect of the present disclosure may be [8] “The information transmission device according to any one of [1] to [7], further including: a notification unit configured to issue notification that the traveling information is being acquired, when the information acquisition unit acquires the traveling information”. In this case, the user can easily recognize whether or not the traveling information is being acquired.

According to the aspect of the present disclosure, the acquired traveling information can be transmitted according to the user's intention.

### BRIEF DESCRIPTION OF THE DRAWINGS

FIG. 1 is a schematic diagram illustrating examples of an information transmission device and an information collection device according to an embodiment.

FIG. 2 is a block diagram illustrating the information transmission device.

FIG. 3 is a diagram illustrating a display example when it is confirmed whether or not to transmit traveling information.

FIG. 4 is a diagram illustrating a display example when a vehicle behavior predicted when an unpermitted control program is executed and an actual vehicle behavior are displayed.

FIG. 5 is a flowchart illustrating a flow of processing of acquiring the traveling information.

FIG. 6 is a flowchart illustrating a flow of processing of transmitting the traveling information.

### DETAILED DESCRIPTION

Hereinafter, an exemplary embodiment will be described with reference to the drawings. In each drawing, the same or equivalent components are denoted by the same reference numerals, and the duplicate descriptions will not be repeated.

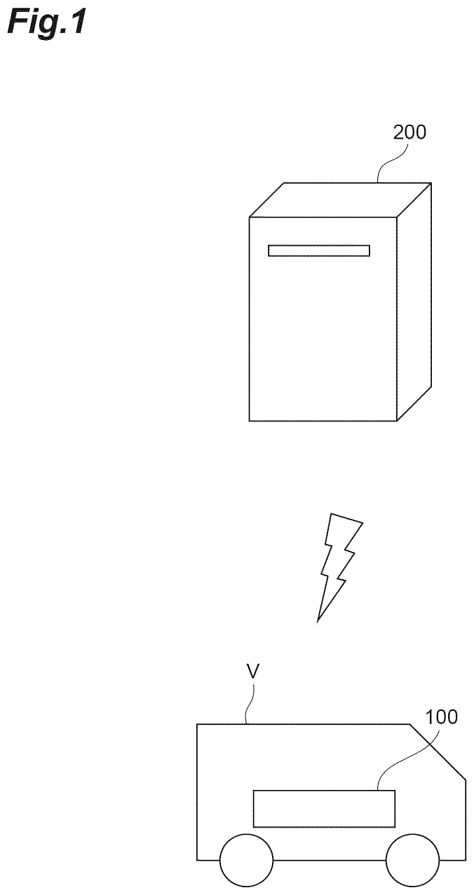

As illustrated in FIG. 1, an information transmission device 100 is mounted in a host vehicle V (vehicle). The information transmission device 100 transmits traveling information including a surrounding situation and vehicle behavior of the host vehicle V to an information collection device 200. For example, the information transmission device 100 can communicate with the information collection device 200 via wireless communication or via wireless communication and wired communication. The information collection device 200 can collect the traveling information from the information transmission device 100 mounted in each of a plurality of vehicles. The traveling information collected by the information collection device 200 can be used, for example, for development of a control program for controlling traveling of the vehicle.

The host vehicle V can travel by manual driving in which a driver performs a driving operation. In addition, the host vehicle V can execute a driving assistance function of assisting the driving of the host vehicle V by the driver, in addition to the manual driving. Alternatively, the host vehicle V may be an autonomous vehicle that can travel by manual driving and also by autonomous driving.

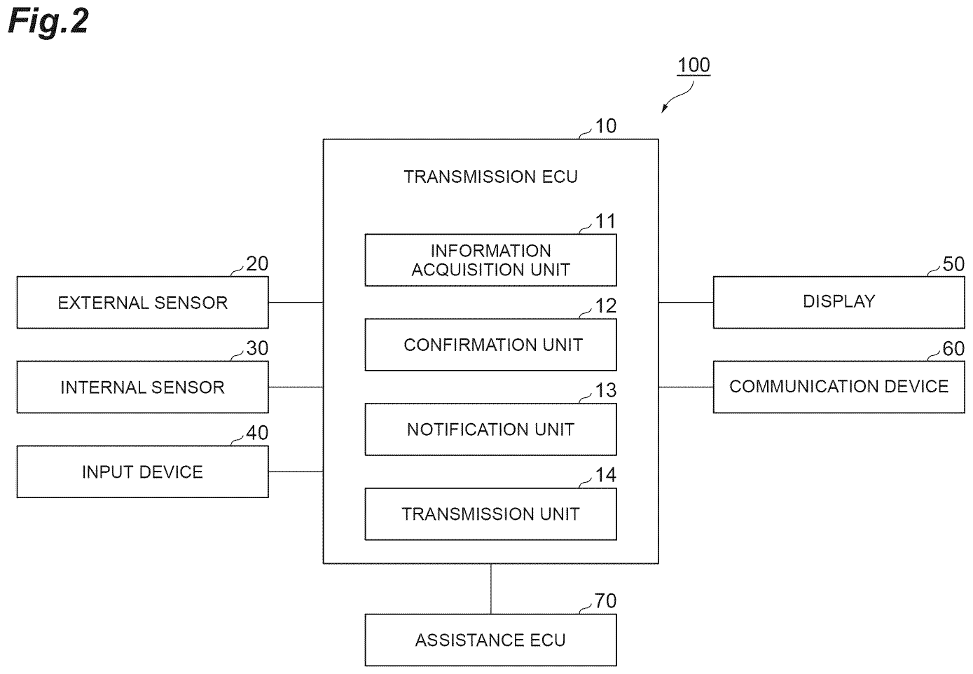

As illustrated in FIG. 2, the information transmission device 100 includes a transmission electronic control unit (ECU) 10 that comprehensively manages the device. The transmission ECU 10 is an electronic control unit including a central processing unit (CPU) and a storage unit. The storage unit is configured by, for example, a read-only memory (ROM), a random-access memory (RAM), an electrically erasable programmable read-only memory (EEPROM), and the like. The transmission ECU 10 implements various functions by executing, for example, a program stored in the storage unit via the CPU. The transmission ECU 10 may be configured by a plurality of electronic control units.

An external sensor 20, an internal sensor 30, an input device 40, a display 50, a communication device 60, and an assistance ECU 70 are connected to the transmission ECU 10. These devices connected to the transmission ECU 10 are mounted in the host vehicle V.

The external sensor 20 is a detection device that detects a surrounding situation of the host vehicle V. The surrounding situation includes other vehicles, pedestrians, obstacles, a compartment line provided on a road, a light state of a traffic signal, and the like around the host vehicle V. The external sensor 20 includes at least one of a camera and a radar sensor. The camera is an imaging device that images an external situation of the host vehicle V. The camera is provided, for example, on a rear side of a windshield of the host vehicle V, and images the front of the host vehicle V. The camera transmits the captured image related to the external situation of the host vehicle V to the transmission ECU 10. The radar sensor is a detection device that detects an object around the host vehicle V by using radio waves (for example, millimeter waves) or light. The radar sensor includes, for example, a millimeter wave radar or a light detection and ranging (LIDAR). The radar sensor transmits information on the detected object to the transmission ECU 10.

The internal sensor 30 is a detection device that detects a state of the host vehicle V. The internal sensor 30 detects a traveling state (vehicle behavior) of the host vehicle V as the state of the host vehicle V. The internal sensor 30 includes, for example, a vehicle speed sensor, an acceleration rate sensor, and a yaw rate sensor as the sensors that detect the traveling state of the host vehicle V. The vehicle speed sensor is a detector that detects a speed of the host vehicle V. As the vehicle speed sensor, a wheel speed sensor can be used, which is provided for wheels of the host vehicle V, a drive shaft that rotates integrally with the wheels, or the like and that detects a rotation speed of each wheel. The vehicle speed sensor transmits the detected vehicle speed information (wheel speed information) to the transmission ECU 10.

The acceleration rate sensor is a detector that detects an acceleration rate of the host vehicle V. The acceleration rate sensor includes, for example, a forward-rearward acceleration rate sensor that detects an acceleration rate of the host vehicle V in a front-rear direction. The acceleration rate sensor may include a lateral acceleration rate sensor that detects a lateral acceleration rate of the host vehicle V. The acceleration rate sensor transmits, for example, acceleration rate information of the host vehicle V to the transmission ECU 10. The yaw rate sensor is a detector that detects a yaw rate (rotation angular velocity) around a vertical axis at a center of gravity of the host vehicle V. For example, a gyro sensor can be used as the yaw rate sensor. The yaw rate sensor transmits the detected yaw rate information of the host vehicle V to the transmission ECU 10.

In addition, the internal sensor 30 detects a driving operation of the host vehicle V by the driver as the state of the host vehicle V. The internal sensor 30 includes, for example, a steering sensor, an accelerator sensor, a brake sensor, and the like as the sensors that detect the driving operation of the host vehicle V by the driver.

The steering sensor detects an operation amount of a steering wheel by the driver. The operation amount of the steering wheel includes a steering angle. The operation amount of the steering wheel may include steering torque. The accelerator sensor detects an operation amount of an accelerator pedal by the driver. The operation amount of the accelerator pedal includes, for example, a depression amount of the accelerator pedal. The brake sensor detects an operation amount of a brake pedal by the driver. The operation amount of the brake pedal includes, for example, a depression amount of the brake pedal. The brake sensor may have an aspect of detecting a master cylinder pressure of a hydraulic brake system. The internal sensor 30 transmits driving operation information related to the detected operation amounts of the driving operation of the driver to the transmission ECU 10.

The input device 40 is a device that receives an input operation to the information transmission device 100 by the user (for example, the driver of the host vehicle V) of the information transmission device 100. The input device 40 may include, for example, a touch panel or a switch.

The display 50 is a display device that visually presents information to the user of the information transmission device 100. The display 50 may be provided, for example, in a vehicle cabin of the host vehicle V. The display 50 may be a center display, a multi-information display (MID), or a head-up display (HUD). The display 50 displays various types of information according to a control signal of the transmission ECU 10.

The display 50 is not limited to being installed in the host vehicle V. For example, as the display 50, a display device of a mobile terminal carried by the user may be used. In this case, as the input device 40, an input device provided in the mobile terminal carried by the user may be used. Further, in this case, the transmission ECU 10 may communicate with the mobile terminal carried by the user via wireless communication or the like.

The communication device 60 is a device that communicates with the information collection device 200. The communication device 60 communicates with the information collection device 200 via wireless communication or via wireless communication and wired communication.

The assistance ECU 70 is an electronic control unit configured by the same device as the transmission ECU 10. The assistance ECU 70 can execute a control program for controlling the traveling of the host vehicle V. For example, the assistance ECU 70 can assist the driving operation of the host vehicle V by the driver or can cause the host vehicle V to autonomously travel by executing the control program. The assistance ECU 70 executes the control program by using the detection result of at least any one of the external sensor 20 or the internal sensor 30.

In addition, the assistance ECU 70 controls the behavior of the host vehicle V by outputting the control signal to actuators mounted in the host vehicle V. The actuators include, for example, a steering actuator that controls the steering of the host vehicle V, a power actuator that controls the speed of the host vehicle V, and a brake actuator that controls the brake of the host vehicle V. The power actuator controls the output of a power source (engine, motor, or the like) of the host vehicle V.

The assistance ECU 70 has (stores), for example, a program for executing crossing control, a program for executing deceleration control when a right turn or left turn is performed, a program for executing control of adjusting an inter-vehicle distance with a cut-in vehicle, and a program for executing control of avoiding collision with another vehicle, as the control programs for controlling the traveling of the host vehicle V.

The crossing control is, for example, control of adjusting a spacing between the host vehicle V and the obstacle when the host vehicle V passes through a side of the obstacle (the other vehicle or the like). When the assistance ECU 70 executes the crossing control, the assistance ECU 70 controls the steering of the host vehicle V. When the assistance ECU 70 executes the crossing control, the assistance ECU 70 may control the speed of the host vehicle V in addition to the steering of the host vehicle V. The deceleration control when the right turn or left turn is performed is, for example, control of decelerating the host vehicle V when the right turn or left turn is performed, in order to prevent the host vehicle V from being too close to an oncoming vehicle, a pedestrian crossing a road, or the like when the host vehicle V turns right or left. When executing the deceleration control when the right turn or left turn is performed, the assistance ECU 70 controls the speed (deceleration rate) of the host vehicle V.

The control of adjusting the inter-vehicle distance with the cut-in vehicle is, for example, control of adjusting the inter-vehicle distance between the host vehicle V and the other vehicle when the other vehicle has entered the front of the host vehicle V on a host vehicle lane on which the host vehicle V travels. For example, in the control of adjusting the inter-vehicle distance with the cut-in vehicle, the assistance ECU 70 adjusts the inter-vehicle distance such that the inter-vehicle distance between the host vehicle V and the other vehicle is equal to or greater than a predetermined inter-vehicle distance. When executing the control of adjusting the inter-vehicle distance between the host vehicle and the cut-in vehicle, the assistance ECU 70 controls the speed (deceleration rate) of the host vehicle V.

The control of avoiding the collision with the other vehicle is, for example, control of adjusting the inter-vehicle distance between the host vehicle V and the other vehicle in front of the host vehicle V in order to prevent the host vehicle V from being too close to the other vehicle in front of the host vehicle V. For example, in the control of avoiding the collision with the other vehicle, the assistance ECU 70 adjusts the inter-vehicle distance such that the inter-vehicle distance between the host vehicle V and the other vehicle in front of the host vehicle V is equal to or greater than a predetermined inter-vehicle distance. When executing the control of avoiding the collision with the other vehicle, the assistance ECU 70 controls the speed (deceleration rate) of the host vehicle V.

As described above, the assistance ECU 70 can execute various types of driving assistance in the host vehicle V by executing various control programs as the control of the traveling of the host vehicle V. When an execution target scene of the control program for controlling the traveling of the host vehicle V has occurred, the assistance ECU 70 executes a corresponding control program among the various control programs described above. The execution target scene indicates a situation in which the corresponding control program is to be executed among various control programs. The corresponding control program is executed during the execution target scene. In other words, the control program is set for each of various execution target scenes. The assistance ECU 70 can determine whether or not the execution target scene has occurred, based on the detection result of the external sensor 20. In addition, the assistance ECU 70 may determine whether or not the execution target scene has occurred, based on the detection result of the external sensor 20 and the detection result of the internal sensor 30.

For example, when the host vehicle V executes the crossing control as the control of the traveling of the host vehicle V, the execution target scene may be a period from when the host vehicle V approaches the obstacle that is a crossing target by a predetermined distance or greater to when the crossing control is executed and the host vehicle V is separated from the obstacle by a predetermined distance or greater. For example, when the deceleration control when the right turn or left turn is performed is executed, the execution target scene may be a period from when the host vehicle V turns right or left (or a predetermined time before a situation in which the host vehicle V turns right or left) to when the deceleration control when the right turn or left turn is performed is executed and the host vehicle V travels by a predetermined distance after turning right or left.

For example, when the control of adjusting the inter-vehicle distance with the cut-in vehicle is executed, the execution target scene may be a period from when the other vehicle in front of the host vehicle V is cut in (or from when the other vehicle that is cut in front of the host vehicle V is detected) to when the host vehicle V travels by a predetermined distance. For example, when the control of avoiding the collision with the other vehicle is executed, the execution target scene may be a period from when the other vehicle as the target is detected in front of the host vehicle V (or from when the inter-vehicle distance between the other vehicle as the target and the host vehicle V is equal to or less than a predetermined distance) to when the host vehicle V travels by a predetermined distance after the execution of the deceleration control of the host vehicle V.

The assistance ECU 70 executes a control program that is permitted in advance among various control programs when the execution target scene of the control program has occurred. For example, the execution permission of the control program executed by the assistance ECU 70 may be set by the user of the host vehicle V, or may be set by a provider of the control program. Hereinafter, the control program that is permitted to be executed in the host vehicle V is referred to as a “permitted control program”. That is, when an execution target scene of the permitted control program among a plurality of control programs stored in the assistance ECU 70 has occurred, the assistance ECU 70 executes the permitted control program and actually controls the traveling of the host vehicle V.

In addition, when the execution target scene of the control program that is not permitted to be executed in the host vehicle V has occurred, the assistance ECU 70 can predict the vehicle behavior of the host vehicle V when the control program is executed. Hereinafter, the control program that is not permitted to be executed in the host vehicle V is referred to as an “unpermitted control program”. That is, when the execution target scene by the unpermitted control program has occurred, the assistance ECU 70 does not actually control the traveling of the host vehicle V, but predicts the vehicle behavior of the host vehicle V when the unpermitted control program is executed. The predicted vehicle behavior of the host vehicle V here includes at least any of the speed of the host vehicle V, a direction of the host vehicle V, a position (absolute position) of the host vehicle V, or a relative position between the host vehicle V and the obstacle around the host vehicle V.

Next, a functional configuration of the transmission ECU 10 will be described. The transmission ECU 10 functionally includes an information acquisition unit 11, a confirmation unit 12, a notification unit 13, and a transmission unit 14.

The information acquisition unit 11 acquires the traveling information including the surrounding situation of the host vehicle V and the vehicle behavior of the host vehicle V for each execution target scene of the control program for controlling the traveling of the host vehicle V. The information acquisition unit 11 can acquire the surrounding situation of the host vehicle V detected by the external sensor 20 as the surrounding situation of the host vehicle V included in the traveling information. In addition, the information acquisition unit 11 can acquire the traveling state of the host vehicle V detected by the internal sensor 30 as the vehicle behavior of the host vehicle V included in the traveling information.

The information acquisition unit 11 may acquire, as the traveling information, the driving operation information of the host vehicle V by the driver in addition to the surrounding situation of the host vehicle V and the vehicle behavior of the host vehicle V. In this case, the traveling information includes the surrounding situation of the host vehicle V, the vehicle behavior of the host vehicle V, and the driving operation information of the host vehicle V by the driver.

As described above, the control program included in the assistance ECU 70 includes the permitted control program and the unpermitted control program. When the execution target scene of any one of the permitted control programs or the unpermitted control program has occurred, the information acquisition unit 11 acquires the traveling information. As described above, the information acquisition unit 11 acquires the traveling information in the execution target scene of the permitted control program permitted to be executed in the host vehicle V. In addition, the information acquisition unit 11 acquires the traveling information in the execution target scene of the unpermitted control program that is not permitted to be executed in the host vehicle V.

The information acquisition unit 11 may determine whether or not the execution target scene of the control program has occurred, based on an instruction from the assistance ECU 70. Alternatively, the information acquisition unit 11 may determine by itself whether or not the execution target scene of the control program has occurred.

For example, an instruction to prohibit the acquisition of the traveling information may be input to the information transmission device 100 by the user of the information transmission device 100 (for example, the driver of the host vehicle V). In this case, the information acquisition unit 11 does not acquire the traveling information. As described above, the user can set whether or not it is acceptable for the information transmission device 100 to acquire the traveling information, for example, by using the input device 40.

By using the traveling information for each execution target scene acquired by the information acquisition unit 11, the surrounding situation of the host vehicle V and the vehicle behavior of the host vehicle V in the execution target scene can be grasped.

For example, it is assumed that the acquired traveling information is traveling information in the execution target scene of the permitted control program. In this case, the traveling information includes the surrounding situation of the host vehicle V and the vehicle behavior of the host vehicle V controlled by executing the permitted control program. In addition, it is assumed that the acquired traveling information is traveling information in the execution target scene by the unpermitted control program. In this case, the traveling information includes the surrounding situation of the host vehicle V and the vehicle behavior of the host vehicle V caused by the driving operation of the driver. When acquiring the traveling information in the execution target scene of the unpermitted control program, the information acquisition unit 11 may acquire the surrounding situation of the host vehicle V, the vehicle behavior of the host vehicle V caused by the driving operation of the driver, and the driving operation information of the host vehicle V by the driver, as the traveling information.

The confirmation unit 12 confirms with the user whether or not it is acceptable to transmit the traveling information to the information collection device 200, for each acquired traveling information. The confirmation unit 12 can confirm whether or not it is acceptable to transmit the traveling information acquired in the execution target scenes of the permitted control program and the unpermitted control program to the information collection device 200. The confirmation unit 12 can confirm whether or not it is acceptable to transmit the traveling information, by using the display 50. In addition, the confirmation unit 12 receives an input of the user as to whether or not it is acceptable to transmit the traveling information, based on the input operation of the input device 40 by the user.

For example, the information acquisition unit 11 acquires the traveling information for each execution target scene from the start of the traveling of the host vehicle V to the end of the traveling. For example, the confirmation unit 12 can confirm whether or not the transmission is acceptable, for each of the plurality of traveling information acquired in the present traveling, after the end of the traveling of the host vehicle V. Alternatively, for example, the confirmation unit 12 may confirm whether or not it is acceptable to transmit the plurality of traveling information acquired from the present to a predetermined period in the past.

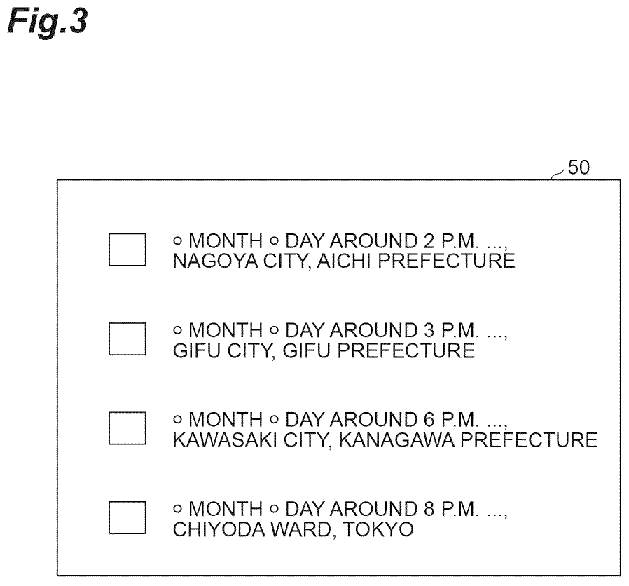

For example, as illustrated in FIG. 3, the confirmation unit 12 displays a date and time and a place at which the traveling information is acquired on the display 50 for each traveling information. Then, the confirmation unit 12 can allow the user to select the traveling information to be transmitted or not to be transmitted. The user can select (input) the traveling information to be transmitted or not to be transmitted, by using the input device 40. The confirmation unit 12 may display, on the display 50, an explanation of the execution target scene from which the traveling information is acquired and/or an image of the external situation at the acquisition, in addition to the date and time and the place at which the traveling information is acquired.

As described above, the confirmation unit 12 can present various types of information in order for the user to easily understand (easily recall) the situation in which the traveling information is acquired, and confirm whether or not it is acceptable to transmit the information. FIG. 3 illustrates a case in which the date and time and the place at which each traveling information is acquired are displayed in a list format for each of the plurality of traveling information to be confirmed. However, the display aspect is not limited to the list format illustrated in FIG. 3.

Here, it is assumed that the traveling information acquired by the information acquisition unit 11 is traveling information in the execution target scene of the unpermitted control program. Hereinafter, a specific example of when the confirmation unit 12 confirms whether or not it is acceptable to transmit the traveling information in the execution target scene of the unpermitted control program will be described. The confirmation unit 12 displays the vehicle behavior predicted when the unpermitted control program is executed and the actual vehicle behavior on the display 50. The confirmation unit 12 performs the display to confirm whether or not it is acceptable to transmit the traveling information in the execution target scene by the unpermitted control program. As described above, the assistance ECU 70 predicts the vehicle behavior of the host vehicle V when the unpermitted control program is executed. For example, the confirmation unit 12 can acquire the vehicle behavior predicted when the unpermitted control program is executed, from the assistance ECU 70.

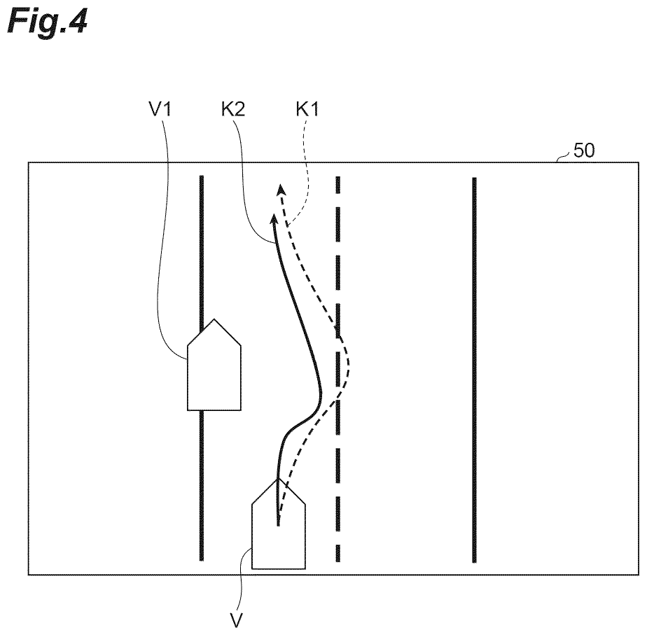

For example, the confirmation unit 12 displays a predicted traveling trajectory as the vehicle behavior predicted when the unpermitted control program is executed, and displays an actual traveling trajectory of the host vehicle V as the actual vehicle behavior. In this case, for example, as illustrated in FIG. 4, the confirmation unit 12 displays a predicted traveling trajectory K1 predicted when the unpermitted control program is executed and a traveling trajectory K2 in which the host vehicle V has actually traveled, on the display 50. In the example illustrated in FIG. 4, a case is illustrated in which the unpermitted control program is the control program for executing the crossing control, and the host vehicle V travels while avoiding a parked vehicle V1 parked on a roadside. That is, the predicted traveling trajectory K1 is a traveling trajectory of the host vehicle V predicted when the crossing control is executed as the unpermitted control program. The traveling trajectory K2 is a traveling trajectory when the driver of the host vehicle V actually performs the driving operation to avoid the parked vehicle V1.

In addition, in the example illustrated in FIG. 4, for example, the predicted traveling trajectory K1 and the traveling trajectory K2 are illustrated on an image diagram when the host vehicle V or the like is viewed from above. However, the configuration is not limited to the diagram in which the host vehicle V or the like is viewed from above. For example, the predicted traveling trajectory K1 and the traveling trajectory K2 may be illustrated on an image diagram when the host vehicle V or the like is viewed from an oblique upper side. In addition, the confirmation unit 12 may present the vehicle behavior predicted when the unpermitted control program is executed and the actual vehicle behavior, by using a video.

The confirmation unit 12 can confirm whether or not it is acceptable to transmit the traveling information, by presenting the predicted traveling trajectory K1 and the traveling trajectory K2 to the user as illustrated in FIG. 4, in addition to the date and time and the place at which the traveling information is acquired. As a result, the user can recognize a difference between the vehicle behavior when the unpermitted control program is executed and the vehicle behavior when the user performs the driving operation.

The confirmation unit 12 calculates a deviation amount between the vehicle behavior predicted when the unpermitted control program is executed and the actual vehicle behavior. When the calculated deviation amount is equal to or greater than a predetermined deviation amount threshold value, the confirmation unit 12 displays the vehicle behavior predicted when the unpermitted control program is executed and the actual vehicle behavior on the display 50. The confirmation unit 12 may perform the display to confirm whether or not it is acceptable to transmit the traveling information in the execution target scene by the unpermitted control program. That is, when the deviation amount between the vehicle behavior predicted when the unpermitted control program is executed and the actual vehicle behavior is less than a predetermined deviation amount threshold value, the confirmation unit 12 does not confirm whether or not it is acceptable to transmit the traveling information. The confirmation unit 12 confirms whether or not it is acceptable to transmit the traveling information, only when the deviation amount is large.

Hereinafter, a specific example of processing of the confirmation unit 12 that confirms whether or not it is acceptable to transmit the traveling information, based on the deviation amount will be described. As a first specific example, it is assumed that the unpermitted control program executes the control of decelerating the host vehicle V. That is, examples of the control executed by the unpermitted control program in this example include the deceleration control when the right turn or left turn is performed, the control of adjusting the inter-vehicle distance with the cut-in vehicle, and the control of avoiding the collision with the other vehicle.

In this example, the confirmation unit 12 can use a deviation amount of the deceleration rate, as the deviation amount. The confirmation unit 12 calculates a deviation amount between a deceleration rate of the host vehicle V predicted when the unpermitted control program is executed and an actual deceleration rate of the host vehicle V. When the calculated deviation amount of the deceleration rate is equal to or greater than a predetermined deviation amount threshold value, the confirmation unit 12 displays the vehicle behavior predicted when the unpermitted control program is executed and the actual vehicle behavior on the display 50. The confirmation unit 12 performs the display to confirm whether or not it is acceptable to transmit the traveling information in the execution target scene by the unpermitted control program. When the unpermitted control program is the control for decelerating the host vehicle V, the confirmation unit 12 may display the vehicle behavior predicted when the unpermitted control program is executed and the actual vehicle behavior, by using a video so that a difference in deceleration rate can be easily grasped.

As a second specific example, it is assumed that the unpermitted control program executes the control of adjusting the spacing between the host vehicle V and the obstacle around the host vehicle V by controlling at least any of the speed or the steering of the host vehicle V. That is, examples of the control executed by the unpermitted control program in this example include the crossing control, the deceleration control when the right turn or left turn is performed, the control of adjusting the inter-vehicle distance with the cut-in vehicle, and the control of avoiding the collision with the other vehicle.

In this example, the confirmation unit 12 can use a deviation amount of the spacing between the host vehicle V and the obstacle, as the deviation amount. The confirmation unit 12 calculates a deviation amount between a spacing between the host vehicle V and the obstacle, which is predicted when the unpermitted control program is executed, and an actual spacing between the host vehicle V and the obstacle. When the calculated deviation amount of the spacing is equal to or greater than a predetermined deviation amount threshold value, the confirmation unit 12 displays the vehicle behavior predicted when the unpermitted control program is executed and the actual vehicle behavior on the display 50. The confirmation unit 12 performs the display to confirm whether or not it is acceptable to transmit the traveling information in the execution target scene by the unpermitted control program.

The spacing between the host vehicle V and the obstacle may be a spacing between the host vehicle V and the obstacle in a front-rear direction of the host vehicle V or in an extension direction of a traveling lane on which the host vehicle V travels. In addition, the spacing between the host vehicle V and the obstacle may be a spacing between the host vehicle V and the obstacle in a vehicle width direction of the host vehicle V or in a width direction of the traveling lane on which the host vehicle V travels.

In addition, when the confirmation unit 12 confirms whether or not it is acceptable to transmit the traveling information, based on the deviation amount, the deviation amount threshold value can be changed based on the speed of the host vehicle V. Specifically, the confirmation unit 12 can set the deviation amount threshold value to be larger when the speed of the host vehicle V is low than when the speed of the host vehicle V is high. When the deviation amount threshold value is increased, the deviation amount between the vehicle behavior predicted when the unpermitted control program is executed and the actual vehicle behavior is less likely to be equal to or greater than the deviation amount threshold value. That is, when the speed of the host vehicle V is low, the confirmation unit 12 makes it difficult to confirm whether or not it is acceptable to transmit traveling information.

When the information acquisition unit 11 acquires the traveling information, the notification unit 13 notifies the driver of the host vehicle V that the traveling information is being acquired. For example, the notification unit 13 can perform display indicating that the traveling information is being acquired, by using the display 50. However, the notification unit 13 is not limited to the use of the display 50, and may perform notification using a lamp and the like other than the display 50.

The transmission unit 14 transmits the traveling information for which the user determines that the transmission is acceptable, to the information collection device 200. Specifically, the transmission unit 14 transmits the traveling information received as the traveling information that is received as the traveling information for which the transmission is acceptable by the confirmation unit 12, to the information collection device 200 by using the communication device 60.

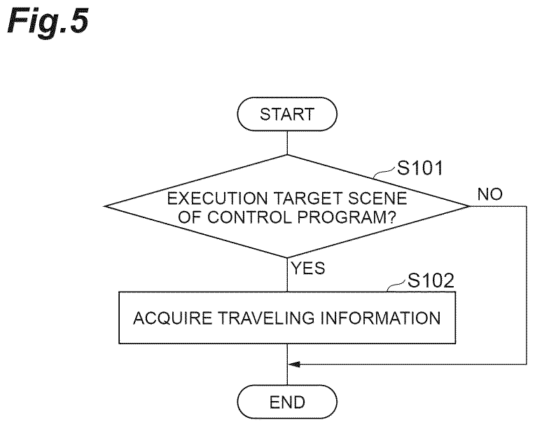

Next, a flow of processing of acquiring the traveling information for each execution target scene of the control program by the information acquisition unit 11 will be described. FIG. 5 is a flowchart illustrating a flow of processing of acquiring the traveling information. In the processing illustrated in FIG. 5, after the processing ends, the processing is started from the start after a predetermined time. As illustrated in FIG. 5, the information acquisition unit 11 determines whether or not the execution target scene of the control program for controlling the traveling of the host vehicle V has occurred (S101). The execution target scene of the control program includes the execution target scene of the permitted control program that is permitted to be executed in the host vehicle V and the execution target scene of the unpermitted control program that is not permitted to be executed in the host vehicle V.

When the execution target scene of the control program has occurred (S101: YES), the information acquisition unit 11 acquires the traveling information including the surrounding situation of the host vehicle V and the vehicle behavior of the host vehicle V (S102). On the other hand, when the execution target scene of the control program has not occurred (S101: NO), the information acquisition unit 11 does not acquire the traveling information and starts the processing again from the start after a predetermined time.

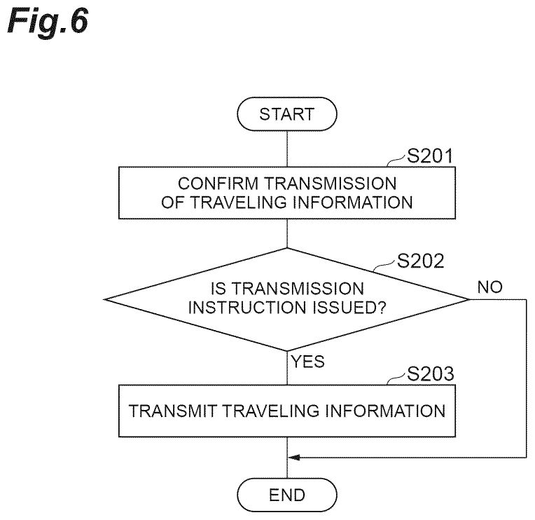

Next, a flow of processing of transmitting the traveling information acquired by the confirmation unit 12 for each execution target scene of the control program will be described. FIG. 6 is a flowchart illustrating a flow of processing of transmitting the traveling information. The processing illustrated in FIG. 6 is started at a predetermined timing at which it is confirmed whether or not it is acceptable to transmit the acquired traveling information, for example, when the present traveling of the host vehicle V ends.

As illustrated in FIG. 6, the confirmation unit 12 confirms with the user whether or not it is acceptable to transmit the traveling information to the information collection device 200, for each acquired traveling information (S201). As described above, the confirmation unit 12 can confirm whether or not it is acceptable to transmit the traveling information, for example, by using a list, or can display and confirm the vehicle behavior for the traveling information in the execution target scene of the unpermitted control program.

Then, the confirmation unit 12 determines whether or not the traveling information for which the user issues an instruction (input) that the transmission is acceptable is present (S202). When there is the traveling information for which the user issues the instruction that the transmission is acceptable (YES in S202), the transmission unit 14 transmits the traveling information for which the user issues an instruction that the transmission is acceptable, to the information collection device 200 (S203). On the other hand, when there is no traveling information for which the user issues the instruction that the transmission is acceptable (S202: NO), the traveling information is not transmitted.

As described above, the information transmission device 100 confirms with the user whether or not it is acceptable to transmit the traveling information acquired for each execution target scene of the control program, when transmitting the traveling information. Then, the information transmission device 100 transmits the traveling information for which the user determines that the transmission is acceptable, to the information collection device 200. Accordingly, the information transmission device 100 can transmit the acquired traveling information according to the user's intention.

The assistance ECU 70 has the unpermitted control program that is not permitted to be executed, in addition to the permitted control program that is permitted to be executed. In addition, when the execution target scene by the unpermitted control program has occurred, the assistance ECU 70 does not actually control the traveling of the host vehicle V, but predicts the vehicle behavior of the host vehicle V when the unpermitted control program is executed. When the execution target scene of the unpermitted control program has occurred, the information acquisition unit 11 acquires the traveling information including the surrounding situation of the host vehicle V and the vehicle behavior of the host vehicle V. In this case, the vehicle behavior included in the traveling information is the vehicle behavior of the host vehicle V by the driving operation of the driver. Then, the confirmation unit 12 displays the vehicle behavior predicted (vehicle behavior predicted by the assistance ECU 70) when the unpermitted control program is executed and the actual vehicle behavior, on the display 50. The confirmation unit 12 performs the display to confirm whether or not it is acceptable to transmit the traveling information in the execution target scene by the unpermitted control program. In this case, the user of the information transmission device 100 can recognize the difference between the vehicle behavior when the unpermitted control program is executed and the actual vehicle behavior by viewing the display 50. Then, the user can determine whether or not to transmit the traveling information in the execution target scene of the unpermitted control program based on this difference.

For example, the information transmission device 100 can present the difference in the vehicle behavior to the user to motivate the user to transmit the traveling information and to provide a determination material. Accordingly, it is possible to increase a possibility that the user determines that it is acceptable to transmit the traveling information, as compared with a case where it is simply confirmed whether or not it is acceptable to transmit the acquired traveling information. Therefore, the information collection device 200 can collect more amount of the traveling information. The collected traveling information can be used for development of the control program for controlling traveling of the vehicle.

For example, the user can more closely feel the situation and the pleasure when the unpermitted control program is used by viewing the vehicle behavior when the unpermitted control program is executed. Then, the user can easily imagine a scene when the unpermitted control program is used, and can easily determine whether or not to permit the execution of the unpermitted control program. In addition, the information transmission device 100 may issue notification that the unpermitted control program is available, in addition to presenting the vehicle behavior.

The confirmation unit 12 displays the vehicle behavior predicted when the unpermitted control program is executed and the actual vehicle behavior on the display 50 when the deviation amount between the vehicle behavior predicted when the unpermitted control program is executed and the actual vehicle behavior is equal to or greater than a predetermined deviation amount threshold value. By performing the display, the confirmation unit 12 confirms whether or not it is acceptable to transmit the traveling information in the execution target scene by the unpermitted control program. In this case, the user can confirm a difference in vehicle behavior and determine whether or not to transmit the traveling information when the deviation amount between the vehicle behavior when the unpermitted control program is executed and the actual vehicle behavior is large. That is, when the deviation amount of the two types of vehicle behavior is small, it is not confirmed whether or not to transmit the traveling information. Therefore, the information transmission device 100 can confirm with the user whether or not to transmit the transmission information, when the deviation amount between the two types of vehicle behavior is large.

Specifically, the unpermitted control program may execute the control of decelerating the host vehicle V. In this case, when the deviation amount between the deceleration rate of the host vehicle V predicted when the unpermitted control program is executed and the actual deceleration rate of the vehicle is equal to or greater than a predetermined deviation amount threshold value, the confirmation unit 12 displays the vehicle behavior predicted when the unpermitted control program is executed and the actual vehicle behavior on the display. By performing the display, the confirmation unit 12 confirms whether or not it is acceptable to transmit the traveling information in the execution target scene by the unpermitted control program. In this case, when the deviation amount between the deceleration rate of the vehicle when the unpermitted control program is executed and the actual deceleration rate of the vehicle is large, the user can confirm the difference in vehicle behavior and determine whether or not to transmit the traveling information.

The unpermitted control program may execute the control of adjusting the spacing between the host vehicle V and the obstacle around the host vehicle V by controlling at least any of the speed or the steering of the host vehicle V. In this case, when the deviation amount between the spacing between the host vehicle V and the obstacle, which is predicted when the unpermitted control program is executed, and the actual spacing between the host vehicle V and the obstacle is equal to or greater than the predetermined deviation amount threshold value, the confirmation unit 12 displays the vehicle behavior predicted when the unpermitted control program is executed and the actual vehicle behavior on the display 50. By performing the display, the confirmation unit 12 confirms whether or not it is acceptable to transmit the traveling information in the execution target scene by the unpermitted control program. In this case, when the deviation amount between the spacing between the host vehicle V and the obstacle when the unpermitted control program is executed and the actual spacing between the host vehicle V and the obstacle is large, the user can confirm the difference in vehicle behavior and determine whether or not to transmit the traveling information.

The confirmation unit 12 may set the deviation amount threshold value to be larger when the speed of the host vehicle V is low than when the speed of the host vehicle V is high. For example, when the speed of the host vehicle V is low, the user (driver) of the host vehicle V may perform the driving operation of intentionally approaching the obstacle very close and passing through the obstacle. In this way, when the speed of the host vehicle V is low, the deviation amount between the vehicle behavior predicted when the control program is executed and the actual vehicle behavior may be intentionally increased by the driving operation intended by the user. Therefore, when the speed of the host vehicle Vis low, the confirmation unit 12 suppresses the confirmation of whether or not it is acceptable to transmit the traveling information, by increasing the deviation amount threshold value. As a result, it is possible to suppress the confirmation of whether or not it is acceptable to transmit the traveling information due to the large deviation amount even though the deviation amount is intentionally increased by the driving operation intended by the user.

The information acquisition unit 11 does not acquire the traveling information when an instruction to prohibit the acquisition of the traveling information is input by the user. In this case, the user can prohibit the acquisition of the traveling information when the acquisition of the traveling information is not desired. Accordingly, the information transmission device can acquire the traveling information according to the user's intention.

The notification unit 13 issues notification that the traveling information is being acquired, when the information acquisition unit 11 acquires the traveling information. For example, the notification unit 13 can issue notification that the traveling information is being acquired, by displaying the traveling information on the display 50. In this case, the user can easily recognize whether or not the traveling information is being acquired.

The embodiment of the present disclosure are described above, but the present disclosure is not limited to the above-described embodiment. The information transmission device 100 may provide the user with a privilege in response to the transmission of the traveling information, for example, in order to prompt the user to transmit the traveling information.

What is claimed is:

1. An information transmission device comprising:
an information acquisition unit configured to acquire traveling information including a surrounding situation and vehicle behavior of a vehicle, for each execution target scene of a control program for controlling traveling of the vehicle;
a confirmation unit configured to confirm with a user whether or not it is acceptable to transmit the traveling information to an information collection device, for each acquired traveling information; and
a transmission unit configured to transmit the traveling information for which the user determines that the transmission is acceptable, to the information collection device.

2. The information transmission device according to claim 1,
wherein the information acquisition unit is configured to acquire the traveling information in the execution target scene of an unpermitted control program that is the control program that is not permitted to be executed in the vehicle, and
the confirmation unit is configured to display vehicle behavior predicted when the unpermitted control program is executed and actual vehicle behavior on a display, and confirm whether or not it is acceptable to transmit the traveling information in the execution target scene of the unpermitted control program.

3. The information transmission device according to claim 2,
wherein the confirmation unit is configured to, when a deviation amount between the vehicle behavior predicted when the unpermitted control program is executed and the actual vehicle behavior is equal to or greater than a predetermined deviation amount threshold value, display the vehicle behavior predicted when the unpermitted control program is executed and the actual vehicle behavior on the display, and confirm whether or not it is acceptable to transmit the traveling information in the execution target scene of the unpermitted control program.

4. The information transmission device according to claim 3,
wherein the unpermitted control program is a control program for executing control of decelerating the vehicle,
the deviation amount is a deviation amount of a deceleration rate, and
the confirmation unit is configured to, when the deviation amount between a deceleration rate of the vehicle predicted when the unpermitted control program is executed and an actual deceleration rate of the vehicle is equal to or greater than a predetermined deviation amount threshold value, display the vehicle behavior predicted when the unpermitted control program is executed and the actual vehicle behavior on the display, and confirm whether or not it is acceptable to transmit the traveling information in the execution target scene of the unpermitted control program.

5. The information transmission device according to claim 3,
wherein the unpermitted control program is a program for executing control of adjusting a spacing between the vehicle and an obstacle around the vehicle by controlling at least any of a speed or steering of the vehicle,
the deviation amount is a deviation amount of a spacing between the vehicle and the obstacle, and
the confirmation unit is configured to, when a deviation amount between a spacing between the vehicle and the obstacle, which is predicted when the unpermitted control program is executed, and an actual spacing between the vehicle and the obstacle is equal to or greater than a predetermined deviation amount threshold value, display the vehicle behavior predicted when the unpermitted control program is executed and the actual vehicle behavior on the display, and confirm whether or not it is acceptable to transmit the traveling information in the execution target scene of the unpermitted control program.

6. The information transmission device according to claim 3,
wherein the confirmation unit is configured to set the deviation amount threshold value to be larger when a speed of the vehicle is low than when the speed of the vehicle is high.

7. The information transmission device according to claim 1,
wherein the information acquisition unit is configured to not acquire the traveling information when an instruction to prohibit the acquisition of the traveling information is input by the user.

8. The information transmission device according to claim 1, further comprising:
a notification unit configured to issue notification that the traveling information is being acquired, when the information acquisition unit acquires the traveling information.
